(19) United States
(12) Patent Application Publication
(10) Pub. No.: US 2017/0365870 A1
(43) Pub. Date: Dec. 21, 2017

(54) POLYMERIC ELECTROLYTE MEMBRANE FOR A REDOX FLOW BATTERY

(71) Applicant: 3M INNOVATIVE PROPERTIES COMPANY, St. Paul, MN (US)

(72) Inventors: Mark S. Schaberg, Lake Elmo, MN (US); Gregory M. Haugen, Edina, MN (US); Steven J. Hamrock, Stillwater, MN (US); Pa N. Xiong, King of Prussia, PA (US)

(21) Appl. No.: 15/525,747

(22) PCT Filed: Nov. 24, 2015
(86) PCT No.: PCT/US2015/062246

§ 371 Date: May 10, 2017

Related U.S. Application Data
(60) Provisional application No. 62/086,956, filed on Dec. 3, 2014.

(51) Int. Cl. H01M 8/1018; H01M 8/18

(52) U.S. Cl. CPC H01M 8/1018; H01M 8/188; H01M 2300/0082; H01M 2008/1095

(57) ABSTRACT

Described herein is a polymeric electrolyte membrane for a redox flow battery comprising (i) a polymer, (ii) a plurality of pendent groups comprising a sulfonic acid, and (iii) a plurality of pendent groups comprising a sulfonamide.

This invention was made with U.S. Government support under Cooperative Agreement DE-AR0000149 awarded by DOE. The U.S. Government has certain rights in this invention.

### TECHNICAL FIELD

Polymeric electrolyte membranes for redox flow batteries are disclosed.

### BACKGROUND

Redox flow batteries (RFBs) are special electrochemical systems that can repeatedly store and convert electrical energy to chemical energy and chemical energy back to electrical energy when needed, based on the reduction/oxidation of elements having different valencies.

A common RFB electrochemical cell configuration includes two opposing electrodes separated by an electrolyte membrane or other separator, and two circulating electrolyte fluids, referred to as the “anolyte” and “catholyte”. The energy conversion between electrical energy and chemical potential occurs at the electrodes when the fluid electrolyte begins to flow through the cell.

Perfluorinated sulfonic acid membranes, such as those available under the trade designation “NAFION” by E.I. du Pont de Nemours and Co., Wilmington, Del., comprise sulfonic groups which allow protons to transfer therethrough in electrochemical cells. However, in the case of vanadium redox flow batteries, vanadium ions can also transfer through the perfluorinated sulfonic acid membranes, which cause self-discharge of the batteries.

### BRIEF DESCRIPTION OF THE DRAWINGS

In the accompanying drawing:

FIG. 1 is a cross-section of an exemplary redox flow battery.

### SUMMARY

There is a desire to identify polymeric membranes for redox flow batteries that are mechanically and chemically durable, while blocking and/or minimizing the transmission of ions between the anolyte and catholyte that cause self-discharge. Advantageously, the polymeric electrolyte membrane provides dimensional stability as well as ion conductivity and selectivity, resulting in redox flow batteries having higher energy efficiency and/or are more cost effective.

In one aspect, a redox flow battery system is described comprising:

(a) an anolyte and catholyte; and

(b) a polymeric electrolyte membrane comprising (i) a polymer, (ii) a plurality of pendent groups comprising a sulfonic acid, and (iii) a plurality of pendent groups comprising a sulfonamide.

In another aspect, a solid polymeric electrolyte membrane is described, wherein the solid polymeric electrolyte membrane is prepared through cast membrane formation of a liquid composition containing (i) a polymer, (ii) a plurality of pendent groups comprising a sulfonic acid, and (iii) a plurality of pendent groups comprising a sulfonamide.

In yet another aspect, a polymeric electrolyte membrane is described comprising (i) a polymer, (ii) a plurality of pendent groups comprising a sulfonic acid, and (iii) a plurality of pendent groups comprising a sulfonamide, wherein the plurality of pendent groups comprising a sulfonamide are distributed substantially uniformly through a cross-section of the polymeric electrolyte membrane.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the terms

“a”, “an”, and “the” are used interchangeably and mean one or more;

“and/or” is used to indicate one or both stated cases may occur, for example A and/or B includes, (A and B) and (A or B);

“equivalent weight” (EW) of a polymer means the weight of polymer which will neutralize one equivalent of base, which includes all protogenic groups including sulfonic acids, sulfonamides, etc.;

“electrolyte membrane” means a membrane comprising ion containing polymers (also known as ion exchange membranes) in which the ion containing polymers typically contain primarily either bound cations or bound anions. The counterions of the polymers' bound ions can migrate through the membrane polymer matrix, particularly under the influence of an electric field or a concentration gradient;

“polymer” refers to a macrostructure having a number average molecular weight (Mn) of at least 10,000 dalton, at least 25,000 dalton, at least 50,000 dalton, at least 100,000 dalton, at least 300,000 dalton, at least 500,000 dalton, at least, 750,000 dalton, at least 1,000,000 dalton, or even at least 1,500,000 dalton and not such a high molecular weight as to prevent processability; and

“polymer backbone” refers to the main continuous chain of the polymer.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.)

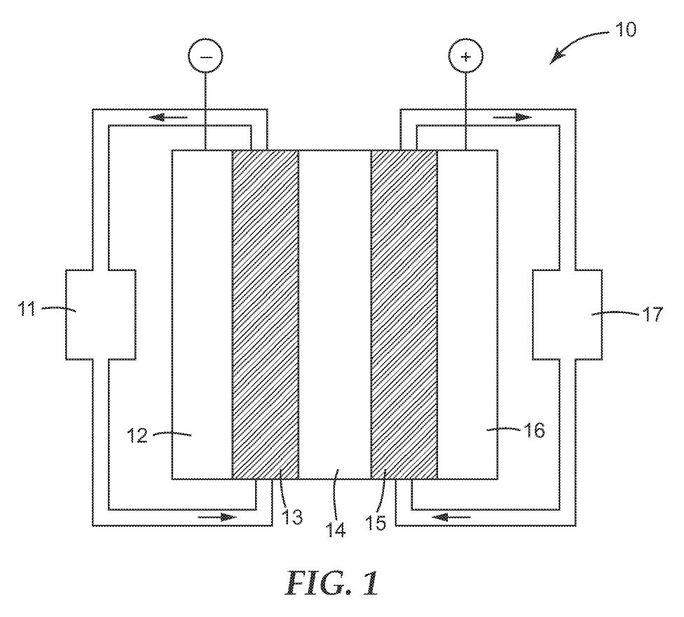

Shown in FIG. 1 is one exemplary embodiment of a single cell redox flow battery system 10, which includes anolyte storage tank 11 for containing an anolyte, current collector plates 12 and 16, anode 13, polymeric electrolyte membrane 14, cathode 15, and catholyte storage tank 17 for containing a catholyte.

Anolyte fluid from the anolyte tank is delivered to the electrochemical cell via an anolyte conduit into an anolyte inlet and exits the electrochemical cell via an anolyte outlet and is delivered back to the anolyte tank. Likewise, catholyte fluid is delivered to a catholyte inlet of the electrochemical cell, exits via a catholyte outlet and is delivered back to the catholyte tank. In some embodiments, more than 1 storage tank is used, for example a tank for storing charged anolyte and a tank for storing discharged anolyte.

In general, an electrochemical cell includes two half-cells, each having either an anolyte or a catholyte. The anolyte and catholyte may comprise different oxidation states of the same chemicals, or they may be different. With the introduction of electrical energy, species from one half-cell lose electrons (oxidation) to their electrode while species from the other half-cell gain electrons (reduction) from their electrode.

In some embodiments of the present disclosure, the redox flow battery systems are described in the context of a vanadium redox flow battery (VRFB), wherein a V³/V^{2|} sulfate solution serves as the negative electrolyte (“anolyte”) and a V⁵⁺/V⁴⁺ sulfate solution serves as the positive electrolyte (“catholyte”). It is to be understood, however, that other redox chemistries are contemplated and within the scope of the present disclosure, including, as non-limiting examples, V^{2|}/V^{3|} vs. Br/ClBr₂, Br₂/Br vs. S/S², Br/Br₂ vs. Zn^{2|}/Zn, Ce⁴/Ce^{3|} vs. V^{2|}/V^{3|}, Fe^{3|}/Fe^{2|} vs. Br₂/Br⁻, Mn²⁺/Mn³⁺ vs. Br2/Br⁻, Fe³⁺/Fe²⁻ vs. Ti²⁺/Ti⁴⁺, etc.

The redox flow battery system 10 operates by circulating the anolyte and the catholyte from respective tanks 11 and 17 into the electrochemical cell using, for example, a pump. The cell operates to discharge or store energy as directed by power and control elements in electrical communication with the electrochemical cell.

In a redox flow battery, the electrolyte membrane separates the electrochemical cell into a positive side and a negative side. The electrolyte membrane is used as a diaphragm allowing selected ions (e.g., H+) to transport across the membrane, modulating the ion balance in the cathode and anode, while preventing other ions (such as vanadium ions) of different valences from mixing with each other and discharging the battery.

Advantageously, it has been found that the electrolyte membranes of the present disclosure have good mechanical strength and chemical stability, and show improved selectivity of protons versus other ions, making these batteries less prone to self-discharge.

The polymeric electrolyte membrane of the present disclosure comprises a plurality of pendent groups comprising a sulfonic acid, and a plurality of pendent groups comprising a sulfonamide. This combination of functional groups can be produced by the synthesis of a polymer comprising both types of pendent groups or through the blending of different polymers.

Both the sulfonic acid and the sulfonamide groups are present as pendent groups off of a polymer backbone.

The plurality of pendent groups comprising a sulfonic acid comprise a —[S(═O)₂O]H and/or —[S(═O)₂O]⁻ᵢM⁺ⁱ moiety wherein M is a cation (e.g., Ca, K, etc.). Such polymers comprising a plurality of pendent groups of sulfonic acid can be made using techniques known in the art and are commercially available, for example as sold under the trade designation “NAFION”. Optionally, the polymer may comprise a plurality of pendent acid fluoride groups, which can be hydrolyzed to sulfonic acid groups. Suitable polymer backbones may comprise polymers or co-polymers of vinyl groups, styrene groups, perfluoroethylene groups, acrylate groups, ethylene groups, propylene groups, epoxy groups, urethane groups, ester groups, and other groups known to those skilled in the art. In one embodiment, the polymer backbone is fluorinated, either partially fluorinated (comprising both carbon-hydrogen bonds and carbon-fluorine bonds) or fully fluorinated (comprising carbon-fluorine bonds and no carbon-hydrogen bonds). The polymer may be highly fluorinated, meaning that the polymer contains fluorine in an amount of 40 wt % or more, typically 50 wt % or more and more typically 60 wt % or more.

The plurality of pendent groups comprising a sulfonamide comprise a —S(═O)₂NH₂;—S(═O)₂NH⁻ᵤM⁺; and/or —S(═O)₂N⁻²ᵢM⁺²ⁱ moiety, wherein M is selected from a cation (e.g., Ca, K, etc.). Such polymers comprising a plurality of pendent groups of sulfonamide can be made using techniques known in the art. For example, an acid fluoride moiety can be reacted with ammonia to yield the sulfonamide. Suitable polymer backbones may comprise polymers or co-polymers of vinyl groups, styrene groups, perfluoroethylene groups, acrylate groups, ethylene groups, propylene groups, epoxy groups, urethane groups, ester groups, and other groups known to those skilled in the art. In one embodiment, the polymer backbone is fluorinated, either partially fluorinated (comprising both carbon-hydrogen bonds and carbon-fluorine bonds) or fully fluorinated (comprising carbon-fluorine bonds and no carbon-hydrogen bonds). The polymer may be highly fluorinated, meaning that the polymer contains fluorine in an amount of 40 wt % or more, typically 50 wt % or more and more typically 60 wt % or more.

In one embodiment, the polymeric electrolyte resin comprises a polymer that comprises a plurality of pendent groups comprising a sulfonic acid and plurality of pendent groups comprising a sulfonamide. For example, a polymer comprising a plurality of acid fluoride groups (—SO₂F) is reacted with a less than stochiometric amount of ammonia which converts a portion of the acid fluoride groups into sulfonamide groups, resulting in a polymer comprising both a plurality of pendent groups comprising acid fluoride and a plurality of pendent groups comprising sulfonamide. The polymer can then be hydrolyzed, as known in the art, for example in the presence of water and optionally a base, to form a polymer comprising a plurality of pendent groups comprising sulfonic acid and a plurality of pendent groups comprising sulfonamide. This polymer can be made into a membrane (as described below) either before or after the hydrolyzation step. As another example, monomers comprising an acid fluoride moiety and monomers comprising a sulfonamide moiety are polymerized together to form a polymer comprising both a plurality of pendent groups comprising acid fluoride and a plurality of pendent groups comprising sulfonamide. This polymer is subsequently hydrolyzed to convert the acid fluoride groups into sulfonic acid groups and made into a membrane, in no particular order.

In another embodiment, the polymeric electrolyte resin comprises (i) a first polymer comprising the plurality of pendent groups comprising a sulfonic acid and (ii) a second polymer comprising the plurality of pendent groups comprising a sulfonamide. For example, a polymer comprising a plurality of acid fluoride groups (—SO₂F) is reacted with an excess of ammonia, which converts the acid fluoride groups into sulfonamide groups, resulting in a polymer comprising a plurality of pendent groups comprising sulfonamide. This polymer can then be blended with a second polymer, which can be a polymer comprising either a plurality of pendent groups comprising acid fluoride (which are subsequently hydrolyzed) or a plurality of pendent groups comprising sulfonic acid. The first and second polymers are blended together either in a liquid solution or dry blended and made into a membrane.

The plurality of pendent groups comprising a sulfonic acid and the plurality of pendent groups comprising a sulfonamide typically are present in an amount sufficient to result in an equivalent weight (EW) of greater than 300, 400, or even 800, and less than 1200, 1100, 1000, or even less than 900.

As mentioned previously, by adjusting the ratio of the pendent groups the selectivity of the electrolyte membrane and the robustness can be optimized In one embodiment, the ratio of the pendent groups comprising a sulfonic acid and the pendent groups comprising a sulfonamide is between 20:1 to 1:2, or even between 10:1 to 3:2.

The electrolyte membranes may be made using techniques known in the art, for example, by casting a liquid composition comprising the polymer, and drying and optionally annealing to form a membrane; or by extrusion of the molten polymer.

In one embodiment, the electrolyte membrane is cast from a liquid composition comprising the polymer and a solvent. Exemplary solvents include water, organic polar solvents such as N,N-dimethylformamide, N,N-dimethylacetamide, dimethylsulfoxide, N-methyl-2-pyrrolidone, and hexamethylphosphoneamide, and alcohols such as methanol and ethanol and the like can be used. The amount of polymer within the liquid composition is preferably within a range of 0.1 to 50% by mass versus the total mass of the solvent. After casting, the solvent is removed, for example, by drying at a low temperature, optionally under reduced pressure.

In one embodiment, the electrolyte membrane may comprise a porous support which is imbibed with a liquid composition comprising the polymer, followed by removal of the solvent to embed the polymer into the pores of the mechanical support. Optionally the polymer can be cross-linked in the pores of the mechanical support. Optionally, the porous support can be imbibed with a monomer which is then polymerized and/or cross-linked to embed the polymer into the pores of the mechanical support. Typically the porous support is electrically non-conductive. Typically, the porous support comprises a fluoropolymer, which is more typically perfluorinated, such as expanded PTFE (polytetrafluoroethylene). Other exemplary porous supports include fiberglass, polymer fibers, fiber mats, perforated films, and porous ceramics.

In addition to the polymer, the polymeric electrolyte membrane may further comprise a filler. Exemplary fillers include silica, titanium dioxide, vanadium oxide or a polymer (e.g., polyvinylidene fluoride, polytetrafluoroethylene, etc.). Such fillers may be added to the liquid composition prior to casting or blended with the polymer prior to extrusion.

The polymeric electrolyte membrane of the present disclosure has a thickness of less than 200 micrometers, 90 micrometers, 60 micrometers, or even 30 micrometers, and greater than 5 micrometers, 10 micrometers, 15 micrometers, 20 micrometers, or even 25 micrometers. When the thickness of the electrolyte membrane for redox batteries is smaller than 5 μm, crossover of non-protonic species increases as does electronic shorting of the redox battery, whereas when the thickness is larger than 200 μm, electrical resistance of the electrolyte membrane increases, and power generation performance of the redox battery tends to decrease.

In one embodiment, the polymeric electrolyte membranes of the present disclosure have reduced crossover of non protonic ions. As previously described, the polymeric electrolyte membranes should allow protons to move between the two electrodes, while preventing the movement of non-proton ions across the membrane. Movement of non-proton ions from one side (e.g., anode) of the redox flow battery to the other side (e.g., cathode) called “crossover” can decrease the coulombic efficiency of the cell. In one embodiment of the present disclosure, the crossover of the polymeric electrolyte membrane, expressed as a material property independent of thickness, for a temperature of 25° C., 1.4 M (molar) VO²⁺ concentration, and 2.6 M sulfuric acid concentration is 5×10⁷ cm²/min or less; 3×10⁷ cm²/min or less; 2×10⁷ cm²/min or less; or even 1×10⁷ cm²/min or less.

In one embodiment, the polymeric electrolyte membranes of the present disclosure have a conductivity of at least 20 mS/cm; 30 mS/cm; 50 mS/cm; 80 mS/cm; or even 90 mS/cm when tested at 25° C. at 100% relative humidity.

Membrane selectivity is related to energy efficiency, coupling both the voltage efficiency and coulombic efficiency into one term. It is a material property independent of thickness when expressed as the permeability times the conductivity. In one embodiment the polymeric electrolyte membranes of the present disclosure have a selectivity of greater than 30 x 10⁴ S min/cm³; greater than 50×10⁻⁴ S min/cm³; or even greater than 55×10⁻⁴ S min/cm³.

The polymeric electrolyte membranes of the present disclosure have the ability to be “tuned” for particular applications. For example, the sulfonic acid moieties tend to increase the conductivity, while the sulfonamide moieties tend to inhibit crossover, but reduce conductivity. The higher the conductivity, the lower the resistance at a given thickness. Thus, one can modify the composition of the polymeric electrolyte membrane by using sulfonic acid and sulfonamide moieties to modify the membrane to work under different operating conditions, thereby operating the redox flow battery more efficiently.

In one embodiment, the polymeric electrolyte membranes of the present disclosure have chemical stability. In other words, the polymeric electrolyte membranes can withstand hydrolytic and oxidative conditions, such as no membrane weight loss (within the margin of error) or no change (within the margin of error compared to a control with no membrane) in VO³⁺ concentration after soaking in a solution comprising 1.4 M VO³⁺ and 2.6 M sulfuric acid for 3 months.

In one embodiment, the polymeric electrolyte membranes of the present disclosure have good physical properties. For example, the polymeric electrolyte membranes do not dissolve in the catholyte and/or anolyte; and the polymeric electrolyte is dimensionally stable upon swelling.

In one embodiment, the electrolyte membrane of the present disclosure may contain various enhancing layers such as glass paper, glass cloth, ceramic nonwoven fabric, porous base materials, and nonwoven fabric as needed. In one embodiment, the electrolyte membrane of the present disclosure is in intimate contact with a second polymeric, layer to form a membrane having two distinct layers. Such second polymeric layers include, for example, a polyfluorosulfonic acid, or a porous support membrane which can be laminated or surface coated onto the electrolyte membrane of the present disclosure.

The polymeric electrolyte membrane of the present disclosure is placed between two electrodes, the anode and cathode, which comprise a metal. In some embodiments, the electrode is for example carbon paper, felt, or cloth, or a porous metal mesh.

The membrane and the two electrodes are sandwiched between current collector plates, which optionally have a field flow pattern etched thereon, and then held together such that each layer is in contact, preferably intimate contact with the adjacent layers.

The anolyte and the cathoyte are fluid electrolytes. In one embodiment, the fluid electrolyte is a liquid electrolyte. In one embodiment the liquid electrolyte is an aqueous solution. The aqueous solution electrolyte includes, for example, an iron-chromium base, titanium-manganese-chromium base, chromium-chromium base, iron-titanium base, or a vanadium base.

In the “charging” mode, power and control elements, connected to a power source, operate to store electrical energy as chemical potential in the catholyte and anolyte. The power source can be any power source known to generate electrical power, including renew able power sources, such as wind, solar, and hydroelectric. Traditional power sources, such as combustion, can also be used.

In the discharge mode, the redox flow battery system is operated to transform chemical potential stored in the catholyte and anolyte into electrical energy that is then discharged on demand by power and control elements that supply an electrical load.

Shown in FIG. 1 is a single electrochemical cell. To obtain high voltage/power systems, a plurality of single electrochemical cells may be assembled together in series to form a stack of electrochemical cells. Several cell stacks may then be further assembled together to form a battery system. A megawatt-level RFB system can be created and generally has a plurality of cell stacks, for example, with each cell stack having more than twenty electrochemical cells. As described for individual electrochemical cells, the stack is arranged with positive and negative current collectors that cause electrons to flow through the cell stack along an axis normal to the polymeric electrolyte membranes and current collectors during electrochemical charge and discharge.

Exemplary embodiments of the present disclosure include, but are not limited to the following:

Embodiment 1. A redox flow battery system comprising:

(a) an anolyte and a catholyte; and

(b) a polymeric electrolyte membrane comprising (i) a polymer, (ii) a plurality of pendent groups comprising a sulfonic acid, and (iii) a plurality of pendent groups comprising a sulfonamide.

Embodiment 2. The redox flow battery system of embodiment 1, wherein the polymer comprises the plurality of pendent groups comprising a sulfonic acid and the plurality of pendent groups comprising a sulfonamide.

Embodiment 3. The redox flow battery system of embodiment 1, wherein the polymeric electrolyte membrane comprises (i) a first polymer comprising the plurality of pendent groups comprising a sulfonic acid, and (ii) a second polymer comprising the plurality of pendent groups comprising a sulfonamide.

Embodiment 4. The redox flow battery system of any one of the previous embodiments, further comprising an anolyte conduit and a catholyte conduit.

Embodiment 5. The redox flow battery system of any one of the previous embodiments, wherein the ratio of the plurality of pendent groups comprising a sulfonic acid to the plurality of pendent groups comprising a sulfonamide is between 20:1 and 1:2.

Embodiment 6. The redox flow battery system of any one of the previous embodiments, wherein the equivalent weight of the plurality of pendent groups comprising a sulfonic acid and the plurality of pendent groups comprising a sulfonamide is less than 1200.

Embodiment 7. The redox flow battery system of any one of the previous embodiments, wherein the polymer is partially fluorinated or perfluorinated.

Embodiment 8. The redox flow battery system of any one of the previous embodiments, wherein the polymeric electrolyte membrane is prepared through cast membrane formation of a liquid composition containing (i) a polymer, (ii) a plurality of pendent groups comprising a sulfonic acid, and (iii) a plurality of pendent groups comprising a sulfonamide.

Embodiment 9. The redox flow battery system of any one of the previous embodiments, wherein the plurality of pendent groups comprising a sulfonamide are distributed substantially uniformly through a cross-section of the polymeric electrolyte membrane.

Embodiment 10. The redox flow battery system of any one of the previous embodiments, wherein the polymeric electrolyte membrane further comprises a filler.

Embodiment 11. The redox flow battery system of embodiment 10, wherein the filler is selected from at least one of silica, titanium dioxide, vanadium oxide, and polyvinylidene fluoride.

Embodiment 12. The redox flow battery system of any one of the previous embodiments, wherein the polymeric electrolyte membrane comprises a support.

Embodiment 13. The redox flow battery system of any one of the previous embodiments, wherein the polymeric electrolyte membrane has a thickness of 25 to 50 micrometers.

Embodiment 14. The redox flow battery system of any one of the previous embodiments, wherein the anolyte is a liquid electrolyte.

Embodiment 15. The redox flow battery system of any one of the previous embodiments, wherein the polymeric electrolyte membrane is in intimate contact with a second polymeric layer to form a multilayer membrane.

Embodiment 16. A solid polymeric electrolyte membrane prepared through cast membrane formation of a liquid composition containing (i) a polymer, (ii) a plurality of pendent groups comprising a sulfonic acid, and (iii) a plurality of pendent groups comprising a sulfonamide.

Embodiment 17. A solid polymeric electrolyte membrane comprising (i) a polymer, (ii) a plurality of pendent groups comprising a sulfonic acid, and (iii) a plurality of pendent groups comprising a sulfonamide, wherein the plurality of pendent groups comprising a sulfonamide are distributed substantially uniformly through a cross-section of the solid polymeric electrolyte membrane.

Embodiment 18. The solid polymeric electrolyte membrane of any one of embodiments 16-17, the polymer comprises (i) the plurality of pendent groups comprising a sulfonic acid, and (ii) the plurality of pendent groups comprising a sulfonamide.

Embodiment 19. The solid polymeric electrolyte membrane of embodiment 16, wherein the liquid composition comprises (i) a first polymer comprising the plurality of pendent groups comprising a sulfonic acid, and (ii) a second polymer comprising the plurality of pendent groups comprising a sulfonamide.

Embodiment 20. The solid polymeric electrolyte membrane of embodiment 17, wherein the solid polymeric electrolyte membrane comprises (i) a first polymer comprising the plurality of pendent groups comprising a sulfonic acid, and (ii) a second polymer comprising the plurality of pendent groups comprising a sulfonamide.

Embodiment 21. The solid polymeric electrolyte membrane of any one of embodiments 16-20, wherein the ratio of the plurality of pendent groups comprising a sulfonic acid to the plurality of pendent groups comprising a sulfonamide is between 20:1 and 1:2.

Embodiment 22. The solid polymeric electrolyte membrane of any one of embodiments 16-21, wherein the net equivalent weight of the plurality of pendent groups comprising a sulfonic acid and the plurality of pendent groups comprising a sulfonamide is less than 1200.

Embodiment 23. The solid polymeric electrolyte membrane of any one of embodiments 16-22, wherein the polymer is partially fluorinated or perfluorinated.

Embodiment 24. The solid polymeric electrolyte membrane of any one of embodiments 16 and -23, wherein the solid polymeric electrolyte membrane further comprises a filler.

Embodiment 25. The solid polymeric electrolyte membrane of embodiment 24, wherein the filler is selected from at least one of silica, titanium dioxide, vanadium oxide, and polyvinylidene fluoride.

Embodiment 26. A process for using a redox flow battery comprising:

providing an electrochemical device comprising a solid polymeric electrolyte membrane, wherein the solid polymeric electrolyte membrane comprises (i) a polymer, (ii) a plurality of pendent groups comprising a sulfonic acid, and (iii) a plurality of pendent groups comprising a sulfonamide, the solid polymeric electrolyte membrane having first and second major surfaces;

introducing a catholyte in contact with the first major surface of the solid polymeric electrolyte membrane;

introducing an anolyte in contact with the second major surface of the solid polymeric electrolyte membrane; and

applying a voltage between the catholyte and the anolyte across the solid polymeric electrolyte membrane.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or Alfa Aesar; Ward Hill, Mass. or known to those skilled in the art unless otherwise stated or apparent.

These abbreviations are used in the following examples: cm=centimeter, min=minutes, hr=hour, mA=milliamp, mol=mole, mg=milligram, mm=millimeter, μm=micrometer, M=molar, MPa=mega Pasal, psig=pounds per square inch gauge, rpm=revolutions per minute, mS =millisiemens, S=siemans, V =volt, and wt =weight.

Methods

Sulfonamide Content

The sulfonamide content was measured by a spectrometer (obtained under the trade designation “BRUKER A500 NMR”, from Bruker Corp., Billerica, Mass.) and calculated by comparing the ¹⁹F spectrum CF₂ peak integrations associated with sulfonyl fluoride, sulfonamide, bissulfonyl imide and sulfonic acid functional groups that are found between −107 and −126 ppm.

Conductivity

The membranes were tested as received with no pretreatment. The membrane samples were submersed in water at 25° C. (100% relative humidity). Conductivity measurements were taken in a Bekk-Tech BT-112 (sold by Scribner Associates Inc., Southern Pines, N.C.) four point probe in-plane conductivity cell under 25° C. full saturated inert gas streams.

Vanadium Permeability

The membrane was tested for vanadium crossover using a permeability cell from PermeGear Inc., Hellertown, Pa. The membrane was placed between the two halves of the cell and mechanically sealed. The temperature was held steady using a chiller/heater at 25° C. In one compartment of the cell, a solution of 1.4 M VO²⁺ and 2.6 M sulfuric acid was added in contact with one side of the membrane. In the compartment on the other side of the membrane an equal volume of 2.6 M sulfuric acid was added. Over the next approximately 24 hours, aliquots were taken and analyzed for the UV-VIS absorption attenuation at about 760 nm corresponding to the VO²⁺ absorption peak. From the slope of the absorption vs. time, a calibration curve, and the dry thickness measured of the membrane, a permeability number was generated.

Selectivity

The selectivity was calculated by multiplying the Vanadium Permeability by the Conductivity.

### Example 1

375 grams of a 695EW perfluorosulfonyl fluoride functional polymer, at 26.9 wt % solids in water, was produced as described in U. S. Pat. No. 7,348,088, added to a 600 ml Parr reactor (obtained from Parr Instruments, Moline, Ill.), and the reactor was sealed. The reactor was cooled to and maintained at 5° C. while stirring at 170 rpm. Vacuum was applied with a vacuum pump (obtained under the trade designation “WELCH 1400N,” Welch Vacuum—Gardner Denver, Niles, Ill.) for 20 minutes. NH₃ (from Matheson, New Brighton, Minn.) was introduced at 90 psi (0.62 MPa) and maintained for 7 hours. The contents were removed and combined with 100 grams of 2 M LiOH. The solution was placed in a desiccator chamber and vacuum applied to remove free NH₃. The solution was then passed through an ion exchange column containing ion exchange resin beads (obtained under the trade designation “AMBERLITE IR120 H+” from Rohm and Haas, Philadelphia, Pa.) and then passed through an ion exchange column containing ion exchange resin beads (obtained under the trade designation “AMBERLITE IRA 68” from Rohm and Haas) before 2 additional passes through a column containing ion exchange resin beads (obtained under the trade designation “AMBERLITE IR120 H+” from Rohm and Haas). The final solution pH was 1.9 and ¹⁹ F NMR showed the sulfonamide functionality made up 13 mole % of the total sulfonamide and sulfonic acid groups. The polymer solution was oven dried to a solid at 85° C.

5.0 grams of the dried polymer was added to 19.6 grams ethanol (Koptec, 200 proof, DLI, King of Prussia, Pa.) and 8.4 grams deionized water, mixed to create a homogeneous solution, and then coated into a 16 mil (0.41 mm) thick wet membrane and dried at 120° C. for 20 minutes followed by 160° C. for 10 minutes and 200° C. for 10 minutes.

### Example 2

A blended sample containing 15 wt % sulfonamide functionality was created by combining 5.59 grams of a perfluorosulfonic acid polymer (825 EW PFSA, available from 3M Co. St. Paul, Minn. at 44 wt % solids, in 82/18 wt % methanol/water, with 7.87 grams of a copolymer containing 40 mole % sulfonic acid and 62 mole % sulfonamide functionality at 10 wt % solids in 80/20 methanol/water and mixed. The membrane was coated at 12 mil (0.30 mm) wet thickness and dried at room temperature for 4 minutes followed by 140° C. for 30 minutes and 200° C. for 10 minutes.

### Example 3

A perfluoro 38 mole % sulfonic acid and 62 mole % sulfonamide membrane was produced by coating a 25% solids (70/30 ethanol/water) solution at 10 mil (0.25 mm) wet thickness and dried at room temperature for 4 minutes followed by 140° C. for 30 minutes and 200° C. for 10 minutes. The copolymer was produced by 110° C. oven drying, to a solid, a polymer solution that had been ion exchanged, in ion exchange resin beads (“AMBERLITE IR120 H⁺”), to pH=3. The polymer solution was a combination of several polymer dispersion reactions, in water or 50/50 wt % water/methanol, created in a Parr reactor at 4-8 wt % solids and 200 rpm, with 3 moles LiOH/sulfonamide and sulfonic acid groups, for 1 hour at 220-250° C. The polymer input came from several ammidation runs, which were prepared by placing ˜150 grams of a 4hr/110° C. vacuum dried 836EW polyperfluorosulfonyl fluoride functional polymer produced as described in U. S. Pat. Nos. 6,624,328 and 7,348,088, into a Parr reactor with ˜200 grams dry acetonitrile and cooling to between −20° C. and −40° C. Anhydrous NH₃ gas was added to between 30 psig (0.21 MPa) and 90 psig (0.62 MPa), while stirring at ˜250 rpm, for —7 hours and allowing it to then warm up overnight under pressure. After venting, the polymer was removed from the acetonitrile and the Parr vessel, and then air dried before dispersing.

### Example 4

330 grams of a 28.6 wt % solids 879EW perfluorosulfonyl fluoride polymer solution was placed in a Parr reactor and sealed. Vacuum was applied with a vacuum pump (obtained under the trade designation “WELCH 1400N”, from Gardner Denver Corp. Niles, Ill.) for 20 minutes and then warmed to 30° C. NH₃ gas was introduced at a pressure of 60 psi (0.41 MPa). Temperature and pressure were maintained for 9.5 hours, after which the NH₃ supply was stopped and the reactor allowed to cool overnight. 178 grams of 2 M LiOH solution was added and the solution was dried in a rotary evaporator (rotovap) to remove volatiles. The solution was then run through a column containing AMBERLITE IR-120 beads, in the H⁺ form, 2 times and oven dried at 80° C. to a solid polymer. The solid was dissolved at 10 wt % solids in an (80/20 wt %) methanol/water solution and put through a column containing ion exchange resin beads (obtained under the trade designation “AMBERLITE IRA 67” from Rohm and Haas), followed by a column containing AMBERLITE IR120 H+ beads, then oven dried at 85° C. A 15 wt % solids (90/10 wt % ethanol/water) solution was prepared and coated at 20 mils (0.51 mm) wet thickness and oven dried at 120° C. for 20 minutes, 160° C. for 10 minutes, and 200° C. for 10 minutes.

### Example 5

Polymer A:1 kg of an overnight 90° C. vacuum oven dried, 821EW perfluorosulfonyl fluoride polymer crumb, produced by a method described in U.S. Pat. Nos. 6,624,328 and 7,348,088, was added to a dry 3 neck flask with a N₂ purge and dry ice condenser. Dry ice/acetone was added for cooling to the flask bath and condenser Ammonia gas was added until the polymer appeared wet (˜1.5 hours). After stopping the ammonia addition, ˜600 ml of dry ice chilled dry acetonitrile was added. The reaction flask was allowed to warm to room temperature (overnight), with stirring and refluxing, while continuing dry ice addition to the condenser for the first 6 hours. The polymer was then removed and allowed to air dry creating a dried sulfonamide(NH₄³⁰ ) functional polymer.

Polymer B- 201grams of vacuum dried Polymer A from above, was added with 1100 grams of dry acetonitrile and 127 grams triethylamine and refluxed with a condenser and N₂ atmosphere for 4 hours. A dry polymer resulted after the liquid was distilled off. The large polymer chunks were broken up and 1100 grams of dry acetonitrile added, and the mixture was cooled to ˜3° C. before adding drop-wise 590 grams of perfluoropropane-1,3 disulfonyl fluoride followed by 127 grams of triethylamine. The mixture was reacted for ˜10 hours and allowed to warm up. The polymer crumb was then placed in a rotary evaporator and processed to dryness, resulting in Polymer B containing bis sulfonylimide and sulfonyl fluoride functional groups.

46 grams of a polymer “crumb” from Polymer B above, was added along with 77 grams of dry CH3CN to a 600 ml Parr reactor and sealed. The reactor was then cooled and the internal pressure reduced with a vacuum pump (obtained under the trade designation “WELCH 1400N”) for 20 minutes. At a temperature of −23° C., NH₃ gas was bled in, cycling on and off to ensure the temperature remained below −16° C. After 1.5 hours, the temperature was −21° C. and the pressure 20 psi (0.14 MPa). The reaction was continued for another 3 hours and allowed to warm up overnight, without further NH₃ addition. The polymer crumb was removed, allowed to air dry and then added to a Parr reactor with 238 grams methanol, 37 grams water and 10 grams of lithium hydroxide monohydrate. This was heated to 210° C. for 1 hour, with stirring, cooled to room temperature, vented, and the solution removed.

The solution was dried in a rotary evaporator to remove volatiles, while adding back 288 grams methanol and 170 grams deionized water over time. 62.5 grams of 2 M LiOH was also added to the solution, as well as, 4.9 grams of lithium hydroxide monohydrate. The solution was then run through a column containing ion exchange beads (“AMBERLITE IR-120), in the H⁺ form, followed by a column containing AMBERLLITE IRA 67 beads and finished with a pass through a column containing ion exchange beads (”AMBERLITE IR-120), in the H⁺ form, before being oven dried at 80° C. to a solid. A solution was prepared at 9.7 wt % solids in 63/37 wt % ethanol/water and a film coated at 30 mils (0.76 mm) wet thickness and dried at 120° C. for 20 minutes, 160° C. for 10 minutes and 200° C. for 10 minutes.

### Example 6

A blended sample containing 10 wt % sulfonamide functionality was created by combining 7.62 grams of 825EW PFSA (perfluorosulfonic acid polymer) at 44 wt % solids, in 82/18 wt % methanol/water, with 6.45 grams of a copolymer containing 38 mole % sulfonic acid and 62 mole % sulfonamide functionality at 10 wt % solids in 80/20 methanol/water and mixed. The membrane was coated at 10 mil (254 micron) wet and dried at room temperature for 2 minutes followed by 140° C. for 30 minutes and 200° C. for 10 minutes.

### Example 7

A blended sample containing 30 wt % sulfonamide functionality was created by combining 2.93 grams of 825EW PFSA (perfluorosulfonic acid polymer) at 44 wt % solids, in 82/18 wt % methanol/water, with 12.1 grams of a copolymer containing 38 mole % sulfonic acid and 62 mole% sulfonamide functionality at 10 wt % solids in 80/20 methanol/water and mixed. The membrane was coated at 20 mil wet and dried at room temperature for 10 minutes followed by 140° C. for 30 minutes and 200° C. for 10 minutes.

### Example 8

335 grams of a 28.6 wt % solids 879EW perfluorosulfonyl fluoride polymer solution was placed in a Parr reactor and sealed. Vacuum was applied with a vacuum pump (obtained under the trade designation “WELCH 1400N”) for several minutes and then warmed to 50° C. NH₃ gas was introduced at a pressure of 50 psi (0.34 MPa.) Temperature and pressure were maintained for 7 hours, after which the NH₃ supply was raised to 90 psi, turned off and the reactor allowed to cool overnight. 7.9 grams of anhydrous LiOH was added to the solution. The solution was then run through a column containing AMBERLITE IR-120 beads, in the H⁺ form, 2 times to drop the pH below 2. The solution was put through a column containing AMBERLITE IRA 67 beads, followed by 2 more passes through a column containing AMBERLITE IR120 H+ beads, then oven dried at 85° C. to a solid polymer. A 18.9 wt % solids (90/10 wt % ethanol/water) solution was prepared and coated at 10 miIs (0.25 mm) wet thickness and oven dried at 120° C. for 20 minutes, 160° C. for 10 minutes, and 200° C. for 10 minutes.

### Example 9

375 grams of a 26.9 wt % solids 695EW perfluorosulfonyl fluoride polymer solution was placed in a 600 ml Parr reactor and sealed. Vacuum was applied with a vacuum pump (obtained under the trade designation “WELCH 1400N”) for 20 minutes and then warmed to 25° C. NH₃ gas was introduced at a pressure of 80 psi (0.55 MPa.) Temperature and pressure were maintained for 7.5 hours, after which the NH₃ supply was stopped and the reactor allowed to cool overnight. 218 grams of 2M LiOH solution was added to the solution. The solution was then run through a column containing AMBERLITE IR-120 beads, in the H⁺ form, 2 times and put through a column containing AMBERLITE IRA 68 beads, followed by a final pass through a column containing AMBERLITE IR120 H+ beads, then oven dried at 85° C. A 16.7 wt % solids (70/30 wt % ethanol/water) solution was prepared and coated at 15 mils (0.38 mm) wet thickness and oven dried at 120° C. for 20 minutes, 160° C. for 10 minutes, and 200° C. for 10 minutes.

### Comparative Example A (CE A)

A 50 micrometer thick perfluorosulfonic acid polymer membrane 1100 EW, available under the trade designation “NAFION 212” from DuPont Chemicals Co., Wilmington, Del.

### Comparative Example B (CE B)

An extruded 175 micrometer-thick perfluorosulfonic acid polymer membrane 1100 EW, available under the trade designation “NAFION 117” from DuPont Chemicals Co., Wilmington, Del.

Some of the samples from above were tested for sulfonamide content, conductivity, VO²⁺ permeability, and selectivity, and the results are shown in Table 1.

TABLE 1

| | | Sulfon- | | VO²⁺ | Selectivity × |
|---|---|---|---|---|---|
| | | amide | Conductivity | permeability × | 10⁻⁴ S |
| Ex | EW | mole % | mS/cm 25° C. | 10⁷ cm²/min | min/cm³ |
| 6 | 825 | 10% | 86 | 3.3 | 26 |
| 2 | 825 | 15% | 60 | 2.7 | 22 |
| 7 | 825 | 30% | 35 | 1.2 | 29 |
| 3 | 836 | 62% | 23 | 0.4 | 56 |
| 1 | 695 | 13% | 91 | 4.2 | 22 |
| 8 | 879 | 10% | 52 | 1.7 | 30 |
| 4 | 879 | 16% | 62 | 1.1 | 55 |
| 9 | 695 | 20% | 80 | 4 | 20 |
| CE A | 1100 | 0% | 71 | 1.6 | 46 |
| CE B | 1100 | 0% | 68 | 5.6 | 12 |

As can be seen by Table 1, it is possible for the polymeric electrolyte membranes of the present disclosure to be “tuned” for particular applications. For example, the polymeric electrolyte membrane of Example 3 has a low VO²⁺ permeability (meaning very low crossover), however this membrane also has low conductivity (i.e., high resistivity). This sort of membrane may be useful in lower current density applications, where the low conductivity has less impact on the performance of the electrochemical cell and the membrane has low crossover. On the other hand, Example 1 has high conductivity, but the VO²⁺ permeability has also increased.

Foreseeable modifications and alterations of this invention will be apparent to those skilled in the art without departing from the scope and spirit of this invention. This invention should not be restricted to the embodiments that are set forth in this application for illustrative purposes.

1. A redox flow battery system comprising:
(a) an anolyte and a catholyte; and
(b) a polymeric electrolyte membrane comprising (i) a polymer, (ii) a plurality of pendent groups comprising a sulfonic acid, and (iii) a plurality of pendent groups comprising a sulfonamide.

2. The redox flow battery system of claim 1, wherein the polymer comprises the plurality of pendent groups comprising a sulfonic acid and the plurality of pendent groups comprising a sulfonamide.

3. The redox flow battery system of claim 1, wherein the polymeric electrolyte membrane comprises (i) a first polymer comprising the plurality of pendent groups comprising a sulfonic acid, and (ii) a second polymer comprising the plurality of pendent groups comprising a sulfonamide.

4. The redox flow battery system of claim 1, wherein the equivalent weight of the plurality of pendent groups comprising a sulfonic acid and the plurality of pendent groups comprising a sulfonamide is less than 1200.

5. The redox flow battery system of claim 1, wherein the polymeric electrolyte membrane is prepared through cast membrane formation of a liquid composition containing (i) a polymer, (ii) a plurality of pendent groups comprising a sulfonic acid, and (iii) a plurality of pendent groups comprising a sulfonamide.

6. The redox flow battery system of claim 1, wherein the plurality of pendent groups comprising a sulfonamide are distributed substantially uniformly through a cross-section of the polymeric electrolyte membrane.

7. The redox flow battery system of claim 1, wherein the polymeric electrolyte membrane has a thickness of 25 to 50 micrometers.

8. A solid polymeric electrolyte membrane prepared through cast membrane formation of a liquid composition containing (i) a polymer, (ii) a plurality of pendent groups comprising a sulfonic acid, and (iii) a plurality of pendent groups comprising a sulfonamide.

9. A solid polymeric electrolyte membrane comprising (i) a polymer, (ii) a plurality of pendent groups comprising a sulfonic acid, and (iii) a plurality of pendent groups comprising a sulfonamide, wherein the plurality of pendent groups comprising a sulfonamide are distributed substantially uniformly through a cross-section of the solid polymeric electrolyte membrane.

10. A process for using a redox flow battery comprising:
providing an electrochemical device comprising a solid polymeric electrolyte membrane, wherein the solid polymeric electrolyte membrane comprises (i) a polymer, (ii) a plurality of pendent groups comprising a sulfonic acid, and (iii) a plurality of pendent groups comprising a sulfonamide, the solid polymeric electrolyte membrane having first and second major surfaces;
introducing a catholyte in contact with the first major surface of the solid polymeric electrolyte membrane;
introducing an anolyte in contact with the second major surface of the solid polymeric electrolyte membrane; and
applying a voltage between the catholyte and the anolyte across the solid polymeric electrolyte membrane.

11. The redox flow battery system of claim 1, further comprising an anolyte conduit and a catholyte conduit.

12. The redox flow battery system of claim 1, wherein the ratio of the plurality of pendent groups comprising a sulfonic acid to the plurality of pendent groups comprising a sulfonamide is between 20:1 and 1:2.

13. The redox flow battery system of claim 1, wherein the polymeric electrolyte membrane further comprises a filler.

14. The redox flow battery system of claim 13, wherein the filler is selected from at least one of silica, titanium dioxide, vanadium oxide, and polyvinylidene fluoride.

15. The redox flow battery system of claim 1, wherein the polymer is partially fluorinated or perfluorinated.

16. The redox flow battery system of claim 1, wherein the polymeric electrolyte membrane comprises a support.

17. The redox flow battery system of claim 1, wherein the anolyte is a liquid electrolyte.

18. The redox flow battery system of claim 1, wherein the polymeric electrolyte membrane is in intimate contact with a second polymeric layer to form a multilayer membrane.

19. The solid polymeric electrolyte membrane of claim 8, wherein the net equivalent weight of the plurality of pendent groups comprising a sulfonic acid and the plurality of pendent groups comprising a sulfonamide is less than 1200.

20. The solid polymeric electrolyte membrane of claim 9, wherein the net equivalent weight of the plurality of pendent groups comprising a sulfonic acid and the plurality of pendent groups comprising a sulfonamide is less than 1200.
